(19) United States
(12) Patent Application Publication
(10) Pub. No.: US 2014/0039955 A1
(43) Pub. Date: Feb. 6, 2014

(54) TASK ASSIGNMENT MANAGEMENT SYSTEM AND METHOD

(71) Applicants: HON HAI PRECISION INDUSTRY CO., LTD., New Taipei (TW); HONG FU JIN PRECISION INDUSTRY (ShenZhen) CO., LTD, ShenZhen (CN)

(72) Inventors: CHUNG-I LEE, New Taipei (TW); DE-YI XIE, Shenzhen (CN); HAI-YUN CHEN, Shenzhen (CN); AN-SHENG LUO, Shenzhen (CN)

(73) Assignees: HON HAI PRECISION INDUSTRY CO., LTD., New Taipei (TW); HONG FU JIN PRECISION INDUSTRY (ShenZhen) CO., LTD, ShenZhen (CN)

(21) Appl. No.: 13/948,199

(22) Filed: Jul. 23, 2013

(30) Foreign Application Priority Data
Aug. 1, 2012 (CN) 1012102713095

(51) Int. Cl. G06Q 10/06

(52) U.S. Cl. CPC G06Q 10/063114
USPC 705/7.14

(57) ABSTRACT

A server calculates a first coefficient according to a degree of difficulty, a degree of urgency, a degree of importance of a task, and calculates an employee scope according to the first coefficient. The server selects a second list from the first list according to the employee scope, and calculates a second coefficient according to a required time and a prescribed time limit for finishing the task. The server selects a third list from the second list according to a workload of each employee in the second list and the second coefficient, and selects an employee from the third list to handle the task and notifies the employee.

### BACKGROUND

1. Technical Field

The embodiments of the present disclosure relate to management technology, and particularly to a task assignment management system and method.

2. Description of Related Art

In a company, employees are assigned with the same or different tasks (e.g., drafting patent application files, or wiring reports). At present, the tasks are manually assigned by a specific person (e.g., a leader of a department), however, the specific person cannot know all information of each employee (e.g., workload of each employee), and a task may be assigned to an employee who cannot finish the task on time. Thus workflow problems may occur. Therefore, there is room for improvement in the art.

### BRIEF DESCRIPTION OF THE DRAWINGS

FIG. 1 is a system view of one embodiment of a task assignment management system.

FIG. 2 is a block diagram of one embodiment of a server included in FIG. 1.

FIG. 3 is a flowchart of one embodiment of a task assignment management method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

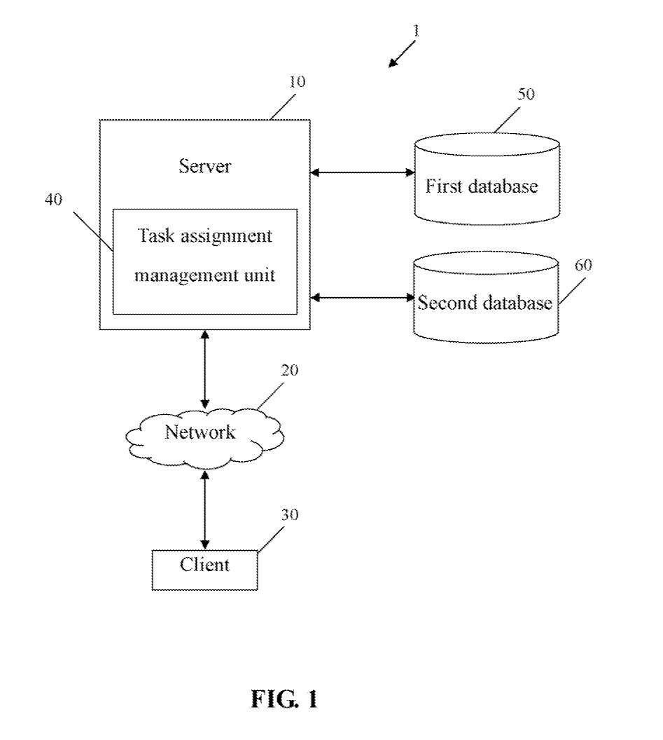

FIG. 1 is a block diagram of one embodiment of a task assignment management system 1. In this embodiment, the task assignment management system 1 includes a server 10, a network 20, a client 30, a first database 50, and a second database 60.

The server 10 includes a task assignment management unit 40. Further details of the task assignment management unit 40 will be described below. The server 10 is located behind a firewall and connected to the client 30 via the network 20. The firewall is used to protect the server 10 from unauthorized access and secure the information of the server 10. The network 20 may be, but is not limited to, a wide area network (e.g., the Internet) or a local area network. Additionally, the client 30 may provide a user interface for a user to access the server 10 to control one or more operations of the server 10. The user may input the password and the name using an input device (e.g., a keyboard) into the user interface on a display device of the client 30 to access server 10. The client 30 may be, but is not limited to, a mobile phone, a tablet computer, a personal computer or other data-processing apparatus.

The server 10 also electronically connects to a first database 50 and a second database 60 using open database connectivity (ODBC) or java database connectivity (JDBC), for example.

The first database 50 stores one or more tasks. Each task is a plan which is created by a specific person (e.g., a CEO of a company) in advance. The content of the task may be, for example, writing a report, handling a product problem, developing a new product, or drafting a patent application file. The task further includes a serial number of the task, a type of the task, a required time and a prescribed time limit for finishing the task, a degree of difficulty, a degree of urgency, a degree of importance of the task. Each task is sorted into a category according to the type of the task. The type of the task may be presented by, but is not limited to, a letter or a number. For example, the task of writing a report may be sorted into the category labeled as an English letter A. The type of the task also corresponds to a department in charge of the task. It is easier to know which department is in charge of the task by the type of the task. The degree of difficulty of the task, which indicates how difficult the task to be finished, may be presented by a first number (e.g., a random number between number one and number ten). The greater the number is, the more difficulty the task is. The degree of urgency of the task, which indicates how urgency the task is, may be presented by a second number (e.g., a random number between number one and number ten). The greater the number is, the more urgent the task is. The degree of importance indicates how important the task is. The degree of importance is presented by a third number (e.g., a random number between number one and number ten). The greater the number is, the more important the task is.

The second database 60 store employee information. The employee information includes a name of each employee, a department corresponding to each employee, a job position of each employee, a seniority of each employee, a workload of each employee, and a working speed of each employee.

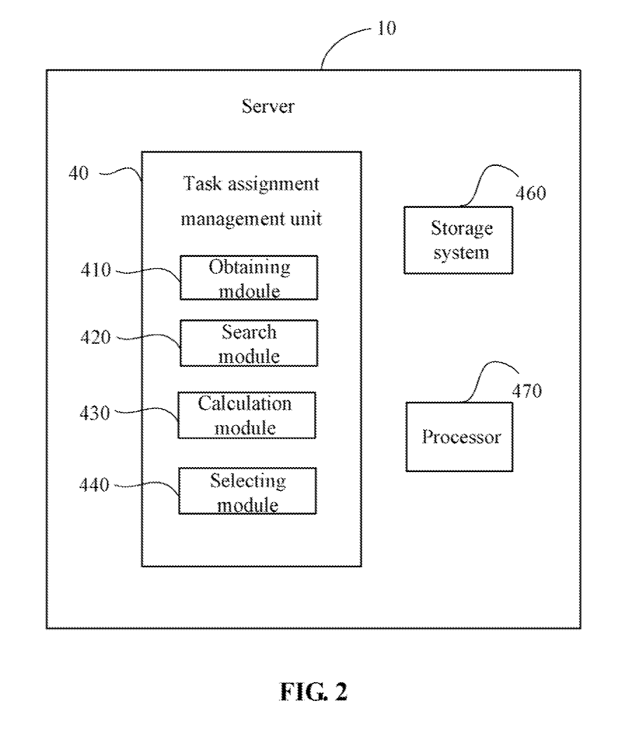

FIG. 2 is a block diagram of one embodiment of the server 10. The server 10 includes a task assignment management unit 40. The task assignment management unit 40 is used to assign the task. In one embodiment, the server 10 includes a storage system 460, and at least one processor 470. In one embodiment, the task assignment management unit 40 includes an obtaining module 410, a search module 420, a calculation module 430, and a selecting module 440. The modules 410-440 may include computerized code in the form of one or more programs that are stored in a storage system 460. The computerized code includes instructions that are executed by the at least one processor 470 to provide functions for the modules 410-440. The storage system 460 may be a memory, such as an EPROM memory chip, hard disk drive (HDD), or flash memory stick.

The obtaining module 410 obtains a task from the first database 50. In one embodiment, when the user inputs a serial number of the task in the user interface, the obtaining module 410 obtains the task according to the serial number of the task.

The search module 420 searches for a department in charge of the task according to the type of the task. In one embodiment, the search module 420 searches the department corresponding to the type of task in the first database 50.

The obtaining module 410 obtains a first list from the second database 60 according to the searched department. The first list includes names of all employees in the searched department.

The calculation module 430 calculates a first coefficient according to a degree of difficulty, a degree of urgency, a degree of importance of the task, and calculates an employee scope according to the first coefficient. In one embodiment, the first coefficient is calculated by a formula as follows: N=a*a1+b*b1+c*c1, where N represents the first coefficient, a represents the degree of difficulty, al represents a weighting of the degree of difficulty, b represents the degree of urgency, b1 represents the weighting of the degree of urgency, c represents the degree of importance, cl represents the weighting of the degree of importance. In one embodiment, if a1=1, b1=2, and c1=3, the formula is changed to: N=a*1+b*2+c*3. The employee scope is calculated by a formula as follows: X>=X0(N/(10*a1+10*b1+10*c1)), where X represents the employee scope, X0 represents a constant, and N represents the first coefficient, a1 represents a weighting of the degree of difficulty, b1 represents the weighting of the degree of urgency, and c1 represents the weighting of the degree of importance. The employee scope may be, but is not limited to, associated with seniority, the job position or the workload. In one embodiment, if the employee scope is associated with seniority, the employee scope is changed to: X>=10(N/(10*a1+10*b1+10*c1)). If the employee scope is associated with the job position, the employee scope is changed to: X>=200(N/(10*a1+10*b1+10*c1)). If the employee scope is associated with the workload, the employee scope is changed to: X>=1000(N/(10*a1+10*b1+10*c1)).

The selecting module 440 selects a second list from the first list according to the employee scope. The second list includes the names of the employees from the first list, where the employee falls within the employee scope. For example, if the first list includes twenty employees and the employee scope is greater or equal to the seniority of five years, and then the second list may include four employees, wherein the seniority of each employee in the second list is greater or equal to the seniority of five years.

The calculation module 430 calculates a second coefficient according to a required time and a prescribed time limit for finishing the task. The second coefficient is calculated by a formula as follows: M=g/h, where M represents the second coefficient, g represents the required time for finishing the task, h represents the prescribed time limit for finishing the task.

The selecting module 440 selects a third list from the second list according to the workload of each employee in the second list and the second coefficient. In one embodiment, if the second list includes four employees, the third list may include three employees, wherein the workload of each employee is greater or equal to a predetermined threshold and the second coefficient of each employee is greater than or equal to another predetermined threshold.

The selecting module 440 selects an employee from the third list to handle the task and notifies the employee. In one embodiment, if the third list includes two or more employee, the selecting module 440 randomly selects one employee from the third list. The selecting module 440 notifies the employee by an e-mail or by short message service.

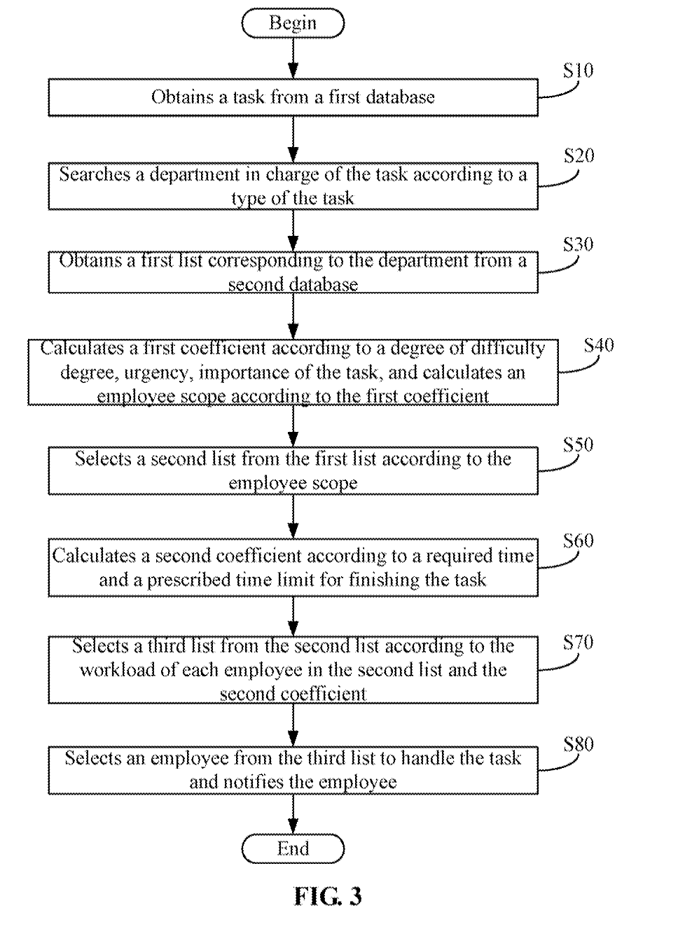

FIG. 3 is a flowchart of one embodiment of a task assignment management method. Depending on the embodiment, additional steps may be added, others deleted, and the ordering of the steps may be changed.

In step S10, the obtaining module 410 obtains a task from the first database 50. For example, if the user inputs a serial number of the task “00001” in the user interface, the obtaining module 410 searches in the database 50 for finding out the task which the serial number is 00001.

In step S20, the search module 420 searches for a department in charge of the task according to the type of the task.

In step S30, the obtaining module 410 obtains a first list from the second database 60 according to the searched department. As mentioned above, the first list includes names of all employees in the searched department. For example, if the searched department includes twenty employees, the first list includes names of the twenty employees.

In step S40, the calculation module 430 calculates a first coefficient according to a degree of difficulty, a degree of urgency, a degree of importance of the task, and calculates an employee scope according to the first coefficient. In one embodiment, the first coefficient is calculated by a formula N as mentioned above. The employee scope is calculated by the formula X as mentioned above.

In step S50, the selecting module 440 selects a second list from the first list according to the employee scope. For example, assuming that the employee scope is associated with seniority, and the employee scope is greater or equal to five years, if the first list includes twenty employees, and then the selecting module 440 selects the names of the employees, wherein the seniority of each employee is greater or equal to five years.

In step S60, the calculation module 430 calculates a second coefficient according to a required time and a prescribed time limit for finishing the task. The second coefficient is calculated by the formula, wherein the formula is as follows: M=g/h, where M represents the second coefficient, g represents the required time for finishing the task, h represents the prescribed time limit for finishing the task.

In step S70, the selecting module 440 selects a third list from the second list according to the workload of each employee in the second list and the second coefficient. In one embodiment, the third list includes the names of the employees from the second list, wherein the workload of each employee is greater or equal to a predetermined threshold and the second coefficient of each employee is greater than or equal to another predetermined threshold.

In step S80, the selecting module 440 selects an employee from the third list to handle the task and notifies the employee. In one embodiment, if the third list includes two or more employee, the selecting module 440 uses a random function to randomly select one employee. The selecting module 440 notifies the employee by an e-mail or a short message.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A server in electronic communication with a first database and a second database, comprising:
at least one processor; and
a storage system and one or more programs that are executed by the at least one processor to perform a task assignment management method, the method comprising:
obtaining a task from the first database;
searching for a department in charge of the task according to a type of the task;
obtaining a first list from the second database according to the searched department, wherein the first list comprises names of all employees in the searched department;
calculating a first coefficient according to a degree of difficulty, a degree of urgency, a degree of importance of the task, and calculating an employee scope according to the first coefficient;
selecting a second list from the first list according to the employee scope;
calculating a second coefficient according to a required time and a prescribed time limit for finishing the task;
selecting a third list from the second list according to a workload of each employee in the second list and the second coefficient; and
choosing an employee from the third list to handle the task and notifies the employee.

2. The server of claim 1, wherein the first coefficient is calculated by a formula N=a*a1+b*b1+c*c1, wherein N represents the first coefficient, a represents the degree of difficulty, a1 represents a weighting of the degree of difficulty, b represents the degree of urgency, b1 represents the weighting of the degree of urgency, c represents the degree of importance, c1 represents the weighting of the degree of importance.

3. The server of claim 2, wherein the employee scope is calculated by a formula X>=X0(N/(10*a1+10*b1+10*c1)), wherein X represents the employee scope, X0 represents a constant, and N represents the first coefficient, a1 represents a weighting of the degree of difficulty, b1 represents the weighting of the degree of urgency, and c1 represents the weighting of the degree of importance.

4. The server of claim 1, wherein the second coefficient is calculated by a formula M=g/h, wherein M represents the second coefficient, g represents the required time for finishing the task, h represents the prescribed time limit for finishing the task.

5. The server of claim 1, wherein the second list comprises the names of the employees from the first list, wherein the employee falls within the employee scope.

6. The server of claim 1, wherein the third list comprises the names of the employees from the second list, wherein the workload of each employee is greater or equal to a predetermined threshold and the second coefficient of each employee is greater or equal to another predetermined threshold.

7. A task assignment management method implemented by a server, the server in electronic communication with a first database and a second database, the method comprising:
obtaining a task from the first database;
searching for a department in charge of the task according to a type of the task;
obtaining a first list from the second database according to the searched department, wherein the first list comprises names of all employees in the searched department;
calculating a first coefficient according to a degree of difficulty, a degree of urgency, a degree of importance of the task, and calculating an employee scope according to the first coefficient;
selecting a second list from the first list according to the employee scope;
calculating a second coefficient according to a required time and a prescribed time limit for finishing the task;
selecting a third list from the second list according to a workload of each employee in the second list and the second coefficient; and
choosing an employee from the third list to handle the task and notifies the employee.

8. The method of claim 7, wherein the first coefficient is calculated by a formula N=a*a1+b*b1+c*c1, wherein N represents the first coefficient, a represents the degree of difficulty, a1 represents a weighting of the degree of difficulty, b represents the degree of urgency, b1 represents the weighting of the degree of urgency, c represents the degree of importance, c1 represents the weighting of the degree of importance.

9. The method of claim 8, wherein the employee scope is calculated by a formula X>=X0(N/(10*a1+10*b1+10*c1)), wherein X represents the employee scope, X0 represents a constant, and N represents the first coefficient, a1 represents a weighting of the degree of difficulty, b1 represents the weighting of the degree of urgency, and c1 represents the weighting of the degree of importance.

10. The method of claim 7, wherein the second coefficient is calculated by a formula M=g/h, wherein M represents the second coefficient, g represents the required time for finishing the task, h represents the prescribed time limit for finishing the task.

11. The method of claim 7, wherein the second list comprises the names of the employees from the first list, wherein the employee falls within the employee scope.

12. The method of claim 7, wherein the third list comprises the names of the employees from the second list, wherein the workload of each employee is greater or equal to a predetermined threshold and the second coefficient of each employee is greater or equal to another predetermined threshold.

13. A non-transitory computer-readable medium having stored thereon instructions that, when executed by a server, the server in electronic communication with a first database and a second database, causing the cloud server to perform a task assignment management method, the method comprising:
obtaining a task from the first database;
searching for a department in charge of the task according to a type of the task;
obtaining a first list from the second database according to the searched department, wherein the first list comprises names of all employees in the searched department;
calculating a first coefficient according to a degree of difficulty, a degree of urgency, a degree of importance of the task, and calculating an employee scope according to the first coefficient;
selecting a second list from the first list according to the employee scope;
calculating a second coefficient according to a required time and a prescribed time limit for finishing the task;
selecting a third list from the second list according to a workload of each employee in the second list and the second coefficient; and
choosing an employee from the third list to handle the task and notifies the employee.

14. The non-transitory computer-readable medium of claim 13, wherein the first coefficient is calculated by a formula N=a*a1+b*b1+c*c1, wherein N represents the first coefficient, a represents the degree of difficulty, a1 represents a weighting of the degree of difficulty, b represents the degree of urgency, b1 represents the weighting of the degree of urgency, c represents the degree of importance, c1 represents the weighting of the degree of importance.

15. The non-transitory computer-readable medium of claim 14, wherein the employee scope is calculated by a formula X>=X0(N/(10*a1+10*b1+10*c1)), wherein X represents the employee scope, X0 represents a constant, and N represents the first coefficient, a1 represents a weighting of the degree of difficulty, b1 represents the weighting of the degree of urgency, and c1 represents the weighting of the degree of importance.

16. The non-transitory computer-readable medium of claim 13, wherein the second coefficient is calculated by a formula M=g/h, wherein M represents the second coefficient, g represents the required time for finishing the task, h represents the prescribed time limit for finishing the task.

17. The non-transitory computer-readable medium of claim 13, wherein the second list comprises the names of the employees from the first list, wherein the employee falls within the employee scope.

18. The non-transitory computer-readable medium of claim 13, wherein the third list comprises the names of the employees from the second list, wherein the workload of each employee is greater or equal to a predetermined threshold and the second coefficient of each employee is greater or equal to another predetermined threshold.
